(19) United States
(12) Patent Application Publication
(10) Pub. No.: US 2026/0160651 A1
(43) Pub. Date: Jun. 11, 2026

(54) A METHOD AND APPARATUS FOR RAPID CIRCULATING TISSUE PRETREATMENT

(71) Applicant: NOVODIAX, INC., Hayward, CA (US)

(72) Inventors: Jin V. WU, Union City, CA (US); Shuo CHEN, Milpitas, CA (US); Songqing ZHAO, Chicago, IL (US); Jianfu WANG, Union City, CA (US)

(21) Appl. No.: 18/706,686

(22) PCT Filed: Oct. 4, 2022
(86) PCT No.: PCT/US2022/045673

§ 371 Date: May 1, 2024

Related U.S. Application Data
(60) Provisional application No. 63/263,358, filed on Nov. 1, 2021.

(51) Int. Cl. G01N 1/31; G01N 1/34; G01N 1/44

(52) U.S. Cl. CPC G01N 1/312; G01N 1/34; G01N 1/44

(57) ABSTRACT

A method and apparatus for the rapid pretreatment of formalin-fixed paraffin-embedded biological specimens, fresh/frozen specimens, and cytology specimens on glass slides before performing immunohistochemistry. The method and apparatus uses heated convection flow of specialized formulations to remove embedded paraffin and prepare the slide tissue samples for immunostaining. Methods of controlling temperature and removal of unwanted reagents and chemicals are described.

This application is a National Stage application claims priority from the international application No. PCT/US22/45673, filed Oct. 4, 2022, which claims priority from U.S. Provisional Application Ser. No. 63/263,358, filed Nov. 1, 2021. The entirely of the aforementioned application is incorporated herein by reference.

### FIELD

The present application relates generally to the field of methods and apparatuses for pretreatment of tissue and optimizations of associated reagents for immunohistochemistry performed upon formalin-fixed paraffin-embedded biological specimens, fresh/frozen specimens, and cytology specimens on glass slides.

### BACKGROUND

For most clinical and research studies, formalin-fixed paraffin-embedded (FFPE) tissue preserves superior morphology, and therefore remains the method of choice for immunohistochemistry (IHC). However, many challenges are caused by the loss of immunoreactivity of many antigens or epitopes caused by fixation in formalin, dehydration and embedding in paraffin. Dewax/deparaffinations (removal of embedding medium), rehydration and antigen/epitope retrieval procedures are critical for successful application of IHC techniques on FFPE tissue.

In general, heat induced epitope retrieval (HIER) procedures have been incorporated in classical staining protocols for paraffin sections, which are initiated by dewaxing of paraffin sections through the use of xylene (or equivalent hydrocarbon solvents) and a series of decreasing alcohol concentrations for rehydration of tissue. However, use of organic solvents for dewaxing and rehydration is not only toxic and time consuming and requires a proper fume hood for ventilation control, but also expensive and harmful to the environment if improperly disposed.

### SUMMARY

An aspect of the application is an automatic tissue pretreatment device for dewaxing, rehydration, epitope retrieval of biological tissue and inactivation of tissue endogenous enzymes comprising: a fluid tank comprising: a tank fluid heating element; a fluid tank temperature sensor; a low fluid level sensor, wherein the low fluid level sensor is installed at lower level inside of the tank to sense a certain level of tank fluid for automatically triggering or stopping any fluid heating; a high fluid level sensor, wherein the high fluid level sensor is installed at higher level inside of the tank to sense a certain level of tank fluid for automatically stopping any inflow fluid pumping; a vertical fluid flow guide; a fluid waste flow outlet; a horizontal fluid flow guide, wherein the horizontal fluid flow guide is connected to the fluid waste flow outlet; a fluid tank temperature controller; and a fluid inflow dispenser, wherein the fluid inflow dispenser is connected a fluid inflow pump, and a fluid inflow heating element, and a fluid inflow temperature sensor, and a fluid inflow temperature controller, wherein the fluid inflow pump, the fluid inflow heating element, the fluid inflow temperature sensor, the fluid inflow temperature controller, and the fluid inflow dispenser work together to provide temperature, time, flow rate, flow direction and fluid ingredient controls, transport and delivery of any inflow fluid.

In certain embodiments, a slide rack holder is positioned above the bottom surface of the tank with a distance ranging from 3 mm to 50 mm, and wherein the tank fluid heating element is positioned under the slide rack holder.

In certain embodiments, the heat element heats the tank fluid under the slide rack holder and generates tank fluid heat convection in the direction parallel to the slide surface, resulting laminar tank fluid flow.

In certain embodiments, the fluid inflow dispenser comprises: a chamber with an array of a plurality of outlets for dispensing heated fluid inflow, wherein the heated fluid inflow is in the same direction as the tank fluid heat convection.

Another aspect of the application is a system comprising the automatic tissue pretreatment device described herein, and an external reservoir; and a suction pump connected to the waste flow outlet.

Another aspect of the application is a kit comprising the automatic tissue pretreatment device described herein, and instructions for dewaxing, rehydration, epitope retrieval of biological tissue and inactivation of tissue endogenous enzymes in a single step.

Another aspect of the application is a method for dewaxing, rehydration, epitope retrieval of biological tissue and inactivation of tissue endogenous enzymes in a single step by using the automatic tissue pretreatment device described herein, the method comprising the steps of: positioning a tank fluid heating element at the bottom surface of a tank containing a buffered fluid, wherein the buffered fluid has a pH in a range of 5 to 9, and further wherein the buffered fluid comprises a surfactant; inflowing a heated fluid into the tank at the bottom of the tank via an inflow dispensing outlet, wherein the inflow dispensing outlet is positioned above the tank fluid heating element and below the one or more slides; placing one or more slides within the buffered fluid, wherein the one or more slides comprise formalin-fixed paraffin-embedded tissue upon a surface of the one or more slides, and further wherein the fluid encompasses the one or more slides so that a top surface of the buffered fluid is covering the formalin-fixed paraffin-embedded tissue; heating the buffered fluid in the tank to a temperature of 95-99° C., wherein the heating of the buffered fluid and the inflow of the heated fluid generates laminar flow across the surface of the one or more slides comprising formalin-fixed paraffin-embedded tissue; removing dissolved wax and other debris from the surface of the buffered fluid in the tank; withdrawing the one or more slides from the buffered fluid after removal of the dissolved wax and other debris.

In certain embodiments, the method further comprising the steps of: positioning a low fluid level sensor in the tank below the position of the one or more slides in the tank, wherein if the low fluid level sensor senses that the level of buffered fluid is below that of the slides then the tank fluid heating element will stop heating the buffered fluid.

In certain embodiments, the method further comprising the steps of: positioning a high fluid level sensor in the tank above the position of the one or more slides in the tank, wherein if the high fluid level sensor senses that the level of buffered fluid is above a certain height within the tank then the inflow of heated fluid to the tank will stop.

In certain embodiments, the method further comprising the steps of: positioning a fluid tank temperature sensor in the tank, wherein if the fluid tank temperature sensor senses that the temperature of the buffered fluid is above 99° C. then heating of the buffered fluid and inflow of the heated fluid will stop, and wherein if the fluid tank temperature sensor senses that the temperature of the buffered fluid is below 95° C. then heating of the buffered fluid and inflow of the heated fluid will continue.

In certain embodiments, the method further comprising the steps of: positioning a fluid inflow dispenser within the tank, wherein the heated fluid inflows into the tank from the fluid inflow dispenser; connecting the fluid inflow dispenser to a fluid inflow pump, wherein the fluid inflow pump transports heated fluid from an external reservoir to the tank through the fluid inflow dispenser.

In certain embodiments, the method further comprising the steps of: positioning a fluid inflow temperature sensor in the tank, wherein if the fluid inflow temperature sensor senses that the temperature of the heated fluid is above 99° C. then inflow of the heated fluid will stop, and wherein if the fluid inflow temperature sensor senses that the temperature of the heated fluid is below 95° C. then the heated fluid will stop and the temperature of the heated fluid will be adjusted to be in the range of 95-99° C.

In certain embodiments, the method further comprising the steps of: positioning a fluid waste outlet within the tank, wherein the fluid waste outlet is at the same height within the tank as the top surface of the buffered fluid comprising dissolved wax and debris; outflowing the dissolved wax and other debris through the fluid waste outlet, wherein the outflow is generated by a suction pump connected to the fluid waster outlet.

In certain embodiments, the method further comprising the steps of: positioning a vertical fluid flow guide adjacent to the one or more slides, wherein the vertical fluid flow guide comprises a heat convection fluid guide that is positioned at a height level above the surface of the one or more slides comprising formalin-fixed paraffin-embedded tissue.

In certain embodiments, the method further comprising the steps of: positioning a horizontal fluid flow guide underneath a portion of the top surface of the buffered fluid, wherein the horizontal fluid flow guide is connected to the fluid waste outlet, and further wherein the outflow of dissolved wax and other debris flows across a surface of the horizontal fluid flow guide.

In certain embodiments, the method further comprising the steps of: placing the one or more slides within a slide rack holder, wherein the slide rack holder is contained with the tank of buffered fluid, and further wherein the slide rack holder positions the one or more slides so that the laminar flow is parallel to the surface of the one or more slides comprising formalin-fixed paraffin-embedded tissue.

In certain embodiments, the method wherein the buffered fluid and the heated fluid comprise: (a) a pH buffer solution with pH value ranging from 5 to pH 9.5, (b) surfactants with total concentrations ranging from 0.01% to 5% (c) formaldehyde scavengers (d) oxidation reagents, wherein the molecule is selected from the group consisting of peroxide moiety, which can serve as an enzymatic substrate for peroxidase, (e) surfactant synergistic reagents, and (f) organic solutions to increase fluid boiling temperature.

In certain embodiments, the method wherein the pH buffer solution can be one or the combination of acetate buffer, MES buffer, citrate buffer, tris buffer, MOPS buffer, Phosphate buffer, HEPES buffer, BORATE buffer, EDTA buffer, and EGTA buffer.

In certain embodiments, the method wherein the surfactants comprise a variety of non-ionic and ionic surfactants with different length of hydrocarbon chains, such as Tween-20, Tween-80, Triton, Decyl Glucoside, Sodium Dodecyl Sulfate, Tergitol, Ecosurf-SA9, and cosurfactant, such as 1-hexanol, 1-heptanol, 1-octanol, 1-nonaol, 1-decanol, 1-undecanol, 1-dodecanol.

In certain embodiments, the method wherein the formaldehyde scavengers can be one or the combination of Sodium metabisulfite, urea, ethylene urea, ethylene glycol, diethylene glycol, glycerol, sorbitol, catechol, and resorcinol.

### BRIEF DESCRIPTION OF THE DRAWINGS

FIG. 1 shows an exemplary rapid circulating tissue pretreatment device.

FIG. 2A shows a 3D front perspective view of an exemplary fluid tank.

FIG. 2B shows a 3D back perspective view of an exemplary fluid tank.

FIG. 2C shows a side view of an exemplary fluid tank.

FIG. 2D shows a front view of an exemplary fluid tank.

While the present disclosure will now be described in detail, and it is done so in connection with the illustrative embodiments, it is not limited by the particular embodiments illustrated in the figures and the appended claims.

### DETAILED DESCRIPTION OF THE INVENTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended claims, the singular forms “a,” “an” and “the” include plural referents unless the content clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to “the value,” greater than or equal to the value” and possible ranges between values are also disclosed, as appropriately understood by the skilled artisan. For example, if the value “10” is disclosed the “less than or equal to 10” as well as “greater than or equal to 10” is also disclosed.

### Efficient Pretreatment of FFPE Tissues

The present application pertains to a method and apparatus that provides a more efficient and simpler form of processing FFPE tissue using an automatic tissue pretreatment device for dewaxing, rehydration, epitope retrieval of biological tissue and inactivation of tissue endogenous enzymes in a single step comprising: (a) a fluid tank, which comprises a slide rack holder, in which a slide rack carrying a plural number of tissue slides is placed into the slide rack holder; biological tissues in the forms of tissue sections; tissue smears or single layer of cells are adhered to the glass slide surface; a tank fluid heating element; a fluid tank temperature sensor; a fluid level sensor; a fluid inflow disperser; a fluid flow guide, a waste flow outlet; buffered fluid tank solutions; heated fluid inflow solutions; and (b) a fluid inflow pump, wherein the fluid inflow pump transports fluid from an external reservoir to the fluid tank through the fluid inflow dispenser, and (c) a fluid inflow heating element, and (d) a fluid inflow temperature sensor, and (e) a fluid inflow temperature controller, wherein the fluid inflow temperature controller actively controls fluid inflow temperature, and (f) a fluid tank temperature controller, wherein the tank temperature controller actively controls tank fluid temperature.

Embodiments of the present application fulfil the functional objectives of rapid tissue pretreatment by means of dewaxing (deparaffination), rehydration, antigen (epitope) retrieval and inactivation of endogenous enzyme in a single step for FFPE tissues, which become suitable for subsequent IHC stains targeted to different types of biomarkers. Specifically, this entire process can be, if needed, finished within 10-20 minutes. In addition, a multiple number of tissue slides, e.g., 20-30 slides can be batch-processed simultaneously. Furthermore, additional batches of tissue slides may be processed continuously to boost the daily processing throughput for these tissue pretreatments.

In an embodiment of the present application, after switching on the power of the tissue pretreatment apparatus, the in-flow pump is activated and starts to pump a specially designed fluid into the fluid tank of the unit. The in-flow fluid is heated by an in-line heating element and its temperature is sensed by a temperature sensor inside of the fluid tank. Thus, the temperature of the in-flow fluid is feedback-controlled by an on-board electronic circuit. The target heating temperature is preset by button input and stored in the unit.

In an embodiment of the present application, after the heated in-flow fluid to the fluid tank reaches to certain level of height, a fluid level sensor located at a lower portion of the fluid tank is triggered which activates the heating of the fluid tank by a heat element located at the bottom of the fluid tank. The temperature of the tank fluid is sensed and monitored by a temperature sensor inside of the fluid tank. Thus, the heat generated by the fluid tank heating element is feedback-controlled by an on-board electronic circuit. The target fluid tank heating temperature is preset by button input and stored in the unit.

In an embodiment of the present application, once the in-flow fluid driven into the fluid tank by the in-flow pump reaches a certain higher level, sensed by a high-level fluid sensor, the in-flow pump and the in-flow heating are stopped by a circuit control board.

In an embodiment of the present application, once the temperature of the tank fluid reaches to a preset value, as sensed by a temperature sensor located inside of the fluid tank, the start signal light for a tissue pretreatment process is lit up, indicating that it is the time for the tissue slides in a slide rack to be placed inside of the fluid tank; then a whole tissue pretreatment procedure can proceed.

In an embodiment of the present application, during the tissue pretreatment procedure, in addition to maintaining the fluid tank fluid temperature by the fluid tank heating element three functions are in activated states: 1) the in-line heated in-flow by a pump; 2) a suction pump with its inlet located at a high level of the fluid associated with a fluid guide; 3) a digital countdown timer which displays remaining time for the tissue pretreatment process.

In an embodiment of the present application, a suction pump is activated with a fluid inlet located on top of a fluid guide which is placed nearly parallel to the top level of the fluid for the function of skimming and removal of melted and solubilized wax debris floating upward due to its lower specific gravity compared to aqueous solutions, toward the upper level of the fluid.

In an embodiment of the present application, the temperature of the fluid inside of the tank is maintained at a preset value during the entire pretreatment process by means of the tank heating and inflow fluid heating, through the fluid temperature sensor and control circuit board.

In an embodiment of the present application, at the end of a timed pretreatment process, the inflow heating, tank heating and inflow pump are turned off, and a buzzer is triggered to remind an operator to remove the tissue slides from the tank. Then the tank fluid is cooling gradually by dissipating heat to the environment. The apparatus is then waiting for the initiation of the next pretreatment cycle.

In another embodiment of the present application, tissue pretreatment near the water boiling temperature blocks endogenous peroxidase activity, which combines the removal of the embedding paraffin media, rehydration, and antigen retrieval of the biological tissue samples into a rapid four-in-one, single step operation.

Certain features adopted in the present application to achieve the objectives described herein are summarized below.

First, the temperature of fluid that bathes the slides is preferably high but below boiling point, so as to efficiently achieve multiple aspects of the pretreatment goals. For aqueous solution, it is preferred to set the temperature in the range of close to boiling point, in an unsealed container such as 90-99° C., 95-96° C., 95-97° C., 95-98° C., 95-99° C. In certain embodiments, the temperature may be in the range of 65-95° C., 70-95° C., 75-95° C., 80-95° C., 85-95° C., 90-95° C., 90-96° C., 90-97° C., 90-98° C., 90-99° C., 95-96° C., 95-97° C., 95-98° C., 95-99° C., 65-99° C.

Secondly, the efficient removal of tissue paraffin embedment by the fluid requires relative motion of the fluid to the tissue surface, but the motion should be relatively gentle laminar flow with minimal turbulence to avoid detaching tissue from its adhesion to the glass slide surface. In certain embodiments, the flow rate of the solution is increased by increasing the temperature of the fluid, but still remains a laminar fluid flow. The direction of fluid motion is preferred to be parallel to the tissue slide surface forming laminar flow. Motions of fluid other than such directions and turbulent flow should be avoided.

Thirdly, the efficiency and concentration of surfactant or similar reagents in the fluid strongly affects efficiency to remove the embedding medium from a slide surface. In certain embodiments, the concentration of surfactant may be varied to enhance the efficiency of removing the embedding medium dependent on the nature of the embedding medium.

Fourthly, the pH and composition of the fluid should be optimal to effectively retrieve epitopes and antigens from formalin fixed tissue sections under high temperature in order to proceed to the subsequent IHC stains. In certain embodiments, the pH of the fluid may be in the range of pH 5-9, 6-8, 7-8, 6-5-8, 7.5-8.

### Slide Placement

In one embodiment of the present application, an apparatus comprises a fluid tank allowing placement of an array of a plural number of slides held by a slide rack. The volume of the fluid tank is substantially larger than that occupied by the slide rack with slides, leaving substantial unoccupied room for the circulatory motions of the fluid.

In one embodiment of the present application, a slide rack holder is positioned inside of a fluid tank and above the bottom of a fluid tank within a certain distance. The slide rack holder allows at least one slide rack to be placed into it or removed from it. The slide rack holder comprises openings at the bottom and sides allowing access of fluid movements with minimal physical barriers. One of ordinary skill will understand that the size and number of the openings in the slide rack can be varied as according to need.

In certain embodiments, the slide rack holder is positioned above the bottom of the fluid tank with a distance ranging from 3 mm to 50 mm.

### Heat Source Position

It is an object of the present application, in certain embodiments, to provide a heat source in the fluid tank at a position under the tissue slides to generate closed-loop fluid circulations driven by heat-induced convections, which increase the flow speed of the fluid relative to the tissue surface to speed up the dewaxing process. In certain embodiments, the flow speed of the fluid relative to the tissue surface is parallel laminar flow with minimal turbulence.

In certain embodiments, the heat element heats the tank fluid under the slide rack holder and generates tank fluid heat convection in a direction parallel to the slide surface, which results in laminar tank fluid flow to increase chemical interactions between the tank fluid and tissues and at the same time minimize turbulence of fluid flow which may disturb adhesion of the tissues to the glass slides.

In one embodiment of the present application, a heating element is installed under the array of a plural number of slides and gapped with a defined space relative to the slides, so that when the fluid located on top of the heating element is heated, its density decreases and it is subjected to buoyancy forces and rises toward the tissue slides. This rising of heated buffered fluid across the spaces under the slides pushes the bulk of the fluid to move upward. In certain embodiments, the gap with defined space between the slides is at least 1-2 cm. One of ordinary skill will understand that the space between slides may be varied according to the demands placed on the size of the device.

In the fluid tank without a significant physical barrier, the heat driven convection flow forms a closed-loop circulation and continuously runs through in parallel to a slide surface forming a laminar flow, which refreshes the fluid at the vicinity of a tissue slide surface with minimal turbulent flow. This closed loop convection-based circulation generated by the proper placement of heating sources and tissue slides greatly facilitates the process of removing paraffin embedment by flow through surfactant, and additionally facilitates the heat-induced antigen retrieval by the fluid containing the pH-control buffer and other components.

In one embodiment of the present application, a vertical sheet forms a vertical fluid flow guide placed close to and in parallel to the side of the slide rack holder with an opening area that forms a heat convection fluid guide located at the upper level of the vertical sheet for the purpose of blocking shortcut convection flow; this enhances the convection-based circulations induced by the tank fluid heating element.

In one embodiment of the present application, a flat horizontal fluid guide is positioned horizontally or nearly horizontally at the top level of the fluid to separate and guide the upper-most layer of fluid. The fluid guide comprises vertical folds, which guide and funnel the upper-most level of fluid flowing toward the outlet connected to the suction pump. The horizontal fluid guide may also be adjusted so that the guide is angled downwards at a shallow gradient; thus, in certain circumstances, the guide is said to be nearly horizontal.

In certain embodiments, a low fluid level sensor is installed on the inside of the said fluid tank at the lower portion of the tank to sense the presence of a certain level of tank fluid for automatically triggering or stopping the buffered fluid heating.

### Inflow of Fluid

It is another object of the present application, in certain embodiments, to provide a temperature-controlled inflow of fluid along the direction of the convection-based fluid circulations. The heated inflow increases the flow speed of convection-based fluid circulation relative to tissue surface and speeds up the dewaxing and other aspects of the pretreatment process.

In certain embodiments, the fluid inflow dispenser comprises an elongated chamber with an array of small-sized inflow outlets for dispensing heated fluid inflow directed toward the fluid flow directions generated by the tank fluid heat convection.

In certain embodiments, the fluid inflow pump, the fluid inflow heating element, the fluid inflow temperature sensor, the fluid inflow temperature controller, and the fluid inflow disperser work together to provide temperature, time, flow rate, flow direction and fluid ingredient controls, transport and delivery of inflow heated fluid.

In one embodiment of the present application, a heated fluid is driven to the fluid tank to follow the same direction of the convection induced closed-loop circulation by a programmable controlled pump, a fluid source from a fluid storage tank, a heating element to create a flow through heated fluid (which has been preheated before inflowing into the tank), and a fluid delivery outlet that orientates the flow direction and distributions of the heated fluid. This active inflow of heated fluid enhances the convection-based circulation and gives options to introduce additional fluid ingredients to boost the dewaxing and antigen retrieval processes. The preferred placement of an inflow outlet is distant from the tissue slides, enabling fresh, clean and heated fluid to access tissues on the slides with minimal turbulence fluid flow. The alternative placement of an inflow outlet is under the tissue slides.

In one embodiment of the present application, an apparatus comprises an inflow fluid pump, an inflow fluid dispenser, an inflow heating element and an inflow fluid temperature sensor. The inflow fluid pump is program controlled to drive stock fluid from the external reservoir to the fluid tank. The fluid is driven by the inflow fluid pump through the inflow heating element and heated to desired temperature as sensed by the inflow temperature sensor. The heated fluid is dispensed to the tank by an inflow dispenser positioned at the inside lower portion of the fluid tank with the dispensing directions aligned with the same directions of fluid convection induced by tank fluid heating.

In certain embodiments, an apparatus comprises a high fluid level sensor positioned at higher level inside of the fluid tank to detect the local presence of the high level of fluid. Once this fluid level is reached and sensed by the said sensor, the inflow pump may be halted or changed in flow rate according to the program needs.

### Outlets

It is yet another object of the present application, in certain embodiments, to provide outlets for the overflow of excess fluid by means of passive or active suction via a pumping mechanism. The fluid waste flow outlet is located at the upper portion of the fluid tank. Its function is not only for eliminating excess fluid, more importantly it is to skim melted, dissolved wax and debris from the surface in the fluid tank to avoid contamination and reattachment of wax droplets when lifting the tissue slides in a rack out from the fluid tank after finishing the tissue pretreatment procedures.

In certain embodiments, the device comprises a suction pump connected to the waste flow outlet for the purpose of removing excess tank fluid and dissolved parafilm debris.

In certain embodiments, the waste flow outlet on the fluid tank is positioned at or close to the top level of the tank fluid.

In one embodiment of the present application, a fluid waste flow outlet connected to a suction pump is positioned at the upper level of the desired fluid level in the fluid tank, for the purpose of 1) removing excess fluid; 2) removing dissolved wax residues floating at the upper surface of the fluid in the tank; 3) facilitating the inflow driven circulations; 4) facilitating convective fluid circulations.

In certain embodiments, a high fluid level sensor is installed on the inside of the said fluid tank at the upper portion of the said tank to sense the high level of tank fluid for automatically stopping the inflow of the fluid.

### Temperature Control

In certain embodiments, an apparatus comprises a temperature sensor to sense the temperature of the fluid in the tank. This sensor together with the tank heating element forms a feedback control of tank fluid temperature.

In certain embodiments, an apparatus comprises a low fluid level sensor positioned at the lower level inside of the fluid tank to detect the local presence of the minimal level of fluid. Without the fluid in the fluid tank detected by the sensor, the heating process is halted for automation and safety control.

### Formulation

In certain embodiments, a buffered fluid is formulated for this apparatus. The fluid has a boiling point that can efficiently melt the paraffin embedment in the tissue sections when heated to nearly boiling. The pH of the fluid is adjusted to a range that the epitope/antigen retrieval reaction is properly catalyzed. The surfactant(s) in the formulation of this fluid can serve as a detergent to facilitate the removal of melted paraffin, as well as a chemical to denature the protein to expose the antigen for immuno-detection. The fluid contains formaldehyde scavengers to absorb any formaldehyde released in the antigen retrieval reaction to shift the reaction equilibrium towards completion. The oxidation chemicals in the formulation for this fluid would inactivate the endogenous enzymatic activity to prevent a background staining issue.

In certain embodiments, the circulating buffered fluid comprises buffer with a pH in the range 5 to 9, or 6-8, or 7-8 for optimal epitope retrieval.

In certain embodiments, the circulating buffered fluid comprises surfactant with a percentage concentration of 0.01% to 5%, or 0.05% to 5%, 0.1% to 5%, 0.5 to 5%, 1% to 5% for rapid and optimal deparaffination.

In certain embodiments, the circulating buffered fluid comprises of formalin scavengers with a percentage concentration of 0.01% to 20%, or 0.05% to 20%, 0.1% to 20%, 0.5 to 20%, 1% to 20%, 2% to 20%, for increasing the efficiency of antigen retrieval process.

In certain embodiments, the circulating buffered fluid comprises nonvolatile organic solutions with a percentage concentration of 10% to 95%, 15% to 95%, 20% to 95%, for elevation of boiling temperature.

In certain embodiments, the automatic tissue pretreatment device described herein is in networked communication with a computer processor, which controls the operation of the device through an in-built computer system or a computer system in corded or wireless communication with the device. In an exemplary embodiment, the computer system includes a memory, a processor, and, optionally, a secondary storage device. In some embodiments, the computer system includes a plurality of processors and is configured as a plurality of, e.g., bladed servers, or other known server configurations. In particular embodiments, the computer system also includes an input device, a display device, and an output device. In some embodiments, the memory includes RAM or similar types of memory. In particular embodiments, the memory stores one or more applications for execution by the processor. In some embodiments, the secondary storage device includes a hard disk drive, floppy disk drive, CD-ROM or DVD drive, or other types of non-volatile data storage. In particular embodiments, the processor executes the application(s) that are stored in the memory or the secondary storage, or received from the internet or other network. In some embodiments, processing by the processor may be implemented in software, such as software modules, for execution by computers or other machines. These applications preferably include instructions executable to perform the functions and methods described herein. The applications preferably provide GUIs through which users may view and interact with the application(s). In other embodiments, the system comprises remote access to control and/or view the system. In certain embodiments, a non-transitory computer readable medium for operating an automatic tissue pretreatment device for dewaxing, rehydration, epitope retrieval of biological tissue and inactivation of tissue endogenous enzymes in one step controls the fluid flow and temperature as described in the methods herein. In certain embodiments, the device described herein is controlled and programmed by a general circuit board with an LED digital display.

In certain embodiments, the automatic tissue pretreatment device described herein is designed so that the laminar flow of fluid relative to the tissue slide surface is achieved by gently rotating a carousal which carries a plural number of tissue slides.

In certain embodiments, the automatic tissue pretreatment device described herein is designed so that the laminar flow of fluid relative to the tissue slide surface is achieved by the active flow of gently pumped bulk fluid.

In certain embodiments, the automatic tissue pretreatment device described herein can be adapted to use in certain situations to avoid abrupt temperature increases when introducing the tissue slides into the heated fluid tank at a high temperature by placing tissue slides into the tank prior to reach to the setting of high working temperature.

In certain embodiments, the automatic tissue pretreatment device described herein can be adapted to use in certain situations to avoid abrupt temperature drops by leaving the tissue slides in the fluid to wait for natural cooling.

The present application is further illustrated by the following examples that should not be construed as limiting. The contents of all references, patents, and published patent applications cited throughout this application, as well as the Figures and Tables, are incorporated herein by reference.

### EXAMPLES

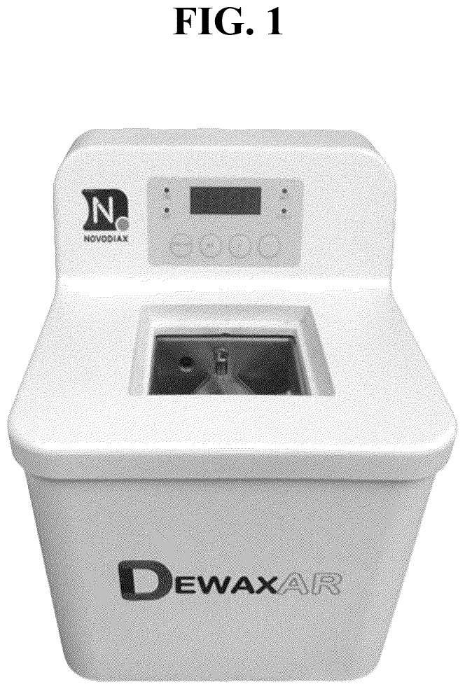

FIG. 1 shows a photograph of a testing model of an exemplary rapid circulating tissue pretreatment device.

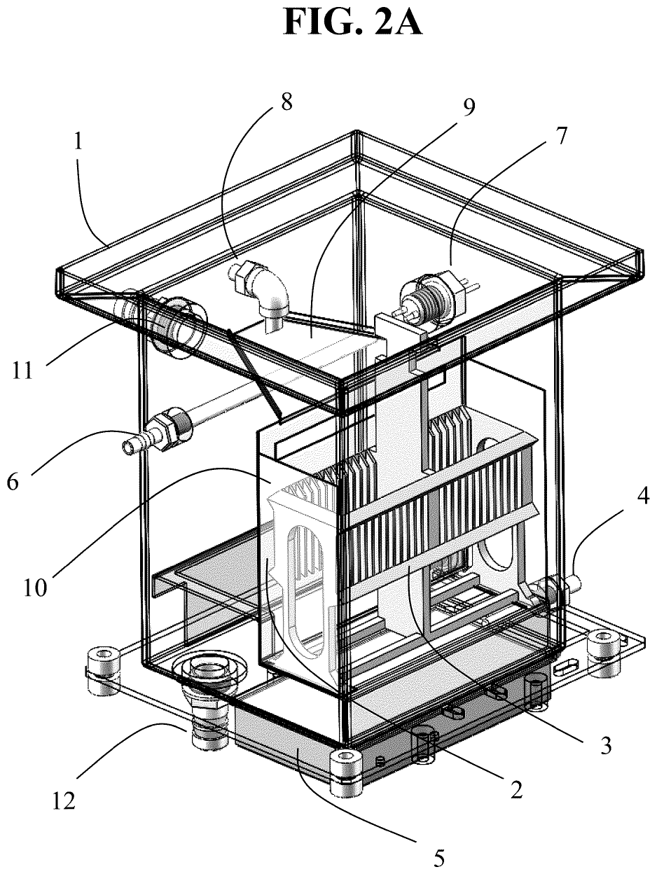

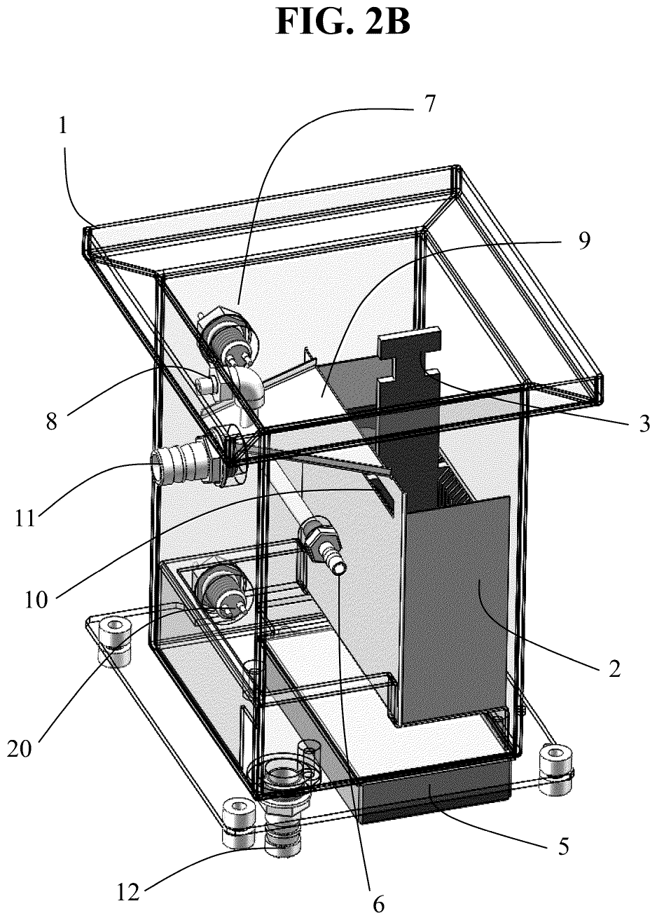

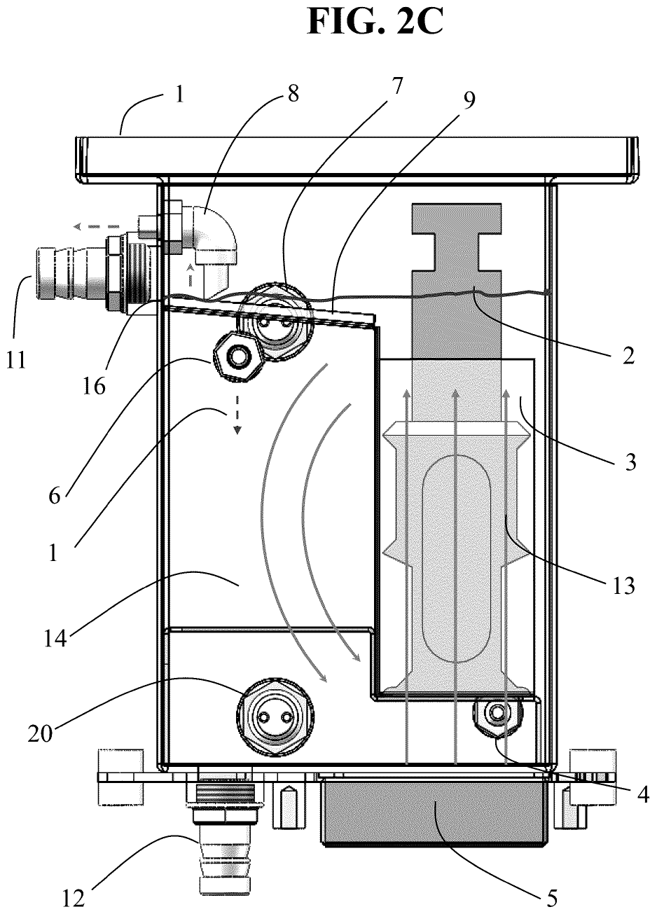

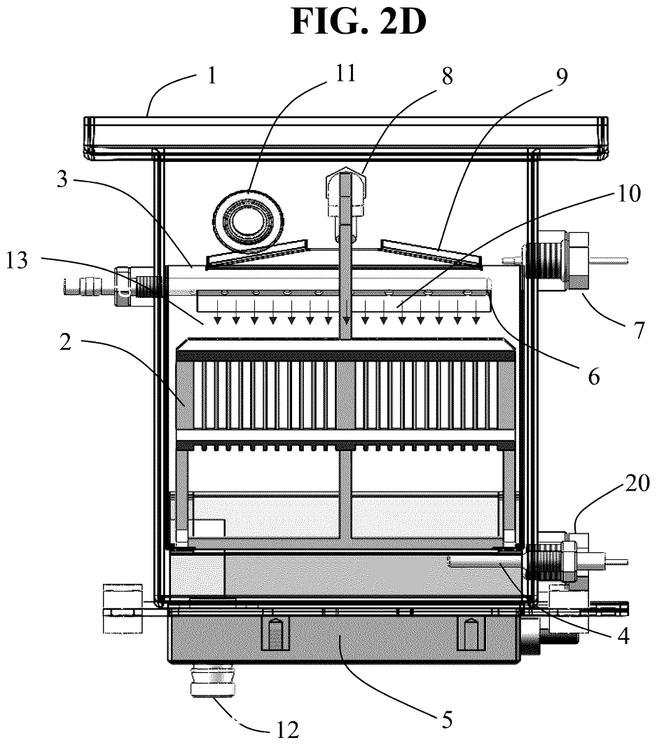

FIG. 2A shows a 3D perspective view from a front viewing angle of an exemplary fluid tank (1) of the rapid circulating tissue pretreatment device. The slide rack holder (2) is located above the fluid tank heating element (5) which is on the bottom surface of the tank. The slide rack (3) holding a plural number of glass slides with tissue samples adhering to the glass tissue slides is inserted into the slide rack holder; the slide rack may then be removed with the slides after pretreatment is completed. A temperature sensor (4) is used for control of the tank fluid heating temperature in the buffered fluid within the tank, which stems from the effect of the heating element and the inflow heated fluid. The heated fluid inflow dispensing outlet (6) is positioned at the lower portion of the fluid tank underneath the slide rack holder. Preferably, the heated fluid inflow dispensing outlet (6) is oriented downward and positioned in the fluid tank at the opposite side of the slide rack holder. The waste flow outlet (8) and the horizontal fluid flow guide (9) are positioned at an upper portion of the fluid tank. The heat convection fluid guide (10) to direct the heat induced convection fluid circulations that rise through the slide rack holder is positioned at the upper level of the fluid tank to aid unobstructed convection flow through the top portion of the buffered fluid and circulation back to the lower portion of the fluid. An overflow outlet (11) is located at an upper level of the fluid tank, while a draining outlet (12) is located at the bottom of the fluid tank. Presence of fluid at high level is detected by the high fluid level sensor (7).

FIG. 2B shows a 3D perspective view of a rear viewing angle of an exemplary fluid tank (1) of the rapid circulating tissue pretreatment device. The slide rack holder (2) is located above the fluid tank heating element (5) and the fluid inflow dispenser (6). The slide rack (3) holding a plural number of glass slides with tissue samples adhering to the glass tissue slides is held within the slide rack holder. The waste flow outlet (8) and the horizontal flow guide (9) are positioned at an upper portion of the fluid tank. The twin vertical guides forming the walls of a funnel on the horizontal flow guide leading to the waste flow outlet can be seen. The heat convection flow guide (10) for accommodating heat induced convection fluid circulation is positioned at the upper level of the fluid tank to aid unobstructed convection flow. As can be seen, the heat convection flow guide is included within a vertical flow guide formed by a vertical sheet which is positioned adjacent to the slides in the slide rack holder with a surface of the vertical sheet facing towards the slides. This provides a vertical fluid flow guide to rising heat convections that pass between the slides and then reach the heat convection flow guide (10), or the top surface of the buffered fluid where the convections may then be channeled by suction towards the waste flow outlet with the direction of the horizontal flow guide. An overflow outlet (11) is located at an upper level of the fluid tank while a draining outlet (12) is located at the bottom of the fluid tank. Presence of fluid at low or high level is detected by the low fluid level sensor (20) and the high fluid level sensor (7).

FIG. 2C shows a side view of the fluid tank to illustrate the two types of circulations in the present exemplary rapid circulating tissue pretreatment device. The tank buffered fluid (16) is heated by the heating element (5) which leads to heat-induced convections (13) which rise upwards from the heating element through the slide rack holder (2) between the gaps in the slide rack (3) in a laminar flow that is parallel to the surface of the glass slides. Heat-induced convections (14) then pass out through the heat convection flow guide to form a closed loop within the tank. Inflow heated fluid (15) coming out from the inflow dispenser (6) works together with suction through the outflow outlet (8) with aid of a suction pump (not shown) to form an open-loop active circulation to remove floating debris from on top of the tank buffered fluid (16). The top surface of the buffered fluid will contain dissolved wax and other debris that is sucked towards the outflow waste flow outlet. The nearly horizontal flow guide (9) is shown at a shallow angle dipping below the top surface of the buffered fluid. An overflow outlet (11) is located at an upper level of the fluid tank, while a draining outlet (12) is located at the bottom of the fluid tank. Presence of fluid at low or high level is detected by the low fluid level sensor (20) and the high fluid level sensor (7).

FIG. 2D shows a front view of the fluid tank (1) to illustrate the inflow heated stream (13) exiting from the inflow dispenser (6) and joining the heat-induced convections (13). In the embodiment shown, the inflow dispenser extends across the tank at the opposite side of the slide rack holder and inflow heated fluid is emitted from multiple small outlets placed along the lower surface of the inflow dispenser. The slide rack holder (3) holds the slide rack (2) and the heat convection stream rises upwards through the gaps between slides. The heat convection flow guide (10) is positioned at the top of the vertical sheet adjacent to the slides and with a surface facing them; the heat convection guide forms an opening above the slide rack through which heated convection streams to form a closed loop. The heated convection streams that do not flow through the heat convection flow guide reach the top surface of the buffered fluid, where the nearly horizontal flow guide (9) forms a funnel towards the waste flow outlet (8). An overflow outlet (11) is located at an upper level of the fluid tank, while a draining outlet (12) is located at the bottom of the fluid tank. Presence of fluid at low or high level is detected by the low fluid level sensor (20) and the high fluid level sensor (7).

While various embodiments have been described above, it should be understood that such disclosures have been presented by way of example only and are not limiting. Thus, the breadth and scope of the subject compositions and methods should not be limited by any of the above-described exemplary embodiments, but should be defined only in accordance with the following claims and their equivalents.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

What is claimed is:

1. An automatic tissue pretreatment device for dewaxing, rehydration, epitope retrieval of biological tissue and inactivation of tissue endogenous enzymes comprising:
a fluid tank comprising:
a tank fluid heating element;
a fluid tank temperature sensor;
a low fluid level sensor,
wherein the low fluid level sensor is installed at lower level inside of the tank to sense a certain level of tank fluid for automatically triggering or stopping any fluid heating;
a high fluid level sensor,
wherein the high fluid level sensor is installed at higher level inside of the tank to sense a certain level of tank fluid for automatically stopping any inflow fluid pumping;
a vertical fluid flow guide;
a fluid waste flow outlet;
a horizontal fluid flow guide,
wherein the horizontal fluid flow guide is connected to the fluid waste flow outlet;
a fluid tank temperature controller; and
a fluid inflow dispenser,
wherein the fluid inflow dispenser is connected a fluid inflow pump, and a fluid inflow heating element, and a fluid inflow temperature sensor, and a fluid inflow temperature controller,
wherein the fluid inflow pump, the fluid inflow heating element, the fluid inflow temperature sensor, the fluid inflow temperature controller, and the fluid inflow dispenser work together to provide temperature, time, flow rate, flow direction and fluid ingredient controls, transport and delivery of any inflow fluid.

2. The automatic tissue pretreatment device of claim 1, wherein a slide rack holder is positioned above the bottom surface of the tank with a distance ranging from 3 mm to 50 mm, and wherein the tank fluid heating element is positioned under the slide rack holder.

3. The automatic tissue pretreatment device of claim 2, wherein the heat element heats the tank fluid under the slide rack holder and generates tank fluid heat convection in the direction parallel to the slide surface, resulting laminar tank fluid flow.

4. The automatic tissue pretreatment device of claim 3, wherein the fluid inflow dispenser comprises:
a chamber with an array of a plurality of outlets for dispensing heated fluid inflow,
wherein the heated fluid inflow is in the same direction as the tank fluid heat convection.

5. A system comprising the automatic tissue pretreatment device of claim 1, and
an external reservoir;
a suction pump connected to the waste flow outlet.

6. A kit comprising the automatic tissue pretreatment device of claim 1, and
instructions for dewaxing, rehydration, epitope retrieval of biological tissue and inactivation of tissue endogenous enzymes in a single step.

7. A method for dewaxing, rehydration, epitope retrieval of biological tissue and inactivation of tissue endogenous enzymes in a single step by using the automatic tissue pretreatment device of claim 1, the method comprising the steps of:
positioning a tank fluid heating element at the bottom surface of a tank containing a buffered fluid,
wherein the buffered fluid has a pH in a range of 5 to 9, and further wherein the buffered fluid comprises a surfactant;
inflowing a heated fluid into the tank via an inflow dispensing outlet,
wherein the inflow dispensing outlet is positioned at the opposite side of the one or more slides;
placing one or more slides within the buffered fluid,
wherein the one or more slides comprise formalin-fixed paraffin-embedded tissue upon a surface of the one or more slides,
and further wherein the fluid encompasses the one or more slides so that a top surface of the buffered fluid is covering the formalin-fixed paraffin-embedded tissue; heating the buffered fluid in the tank to a temperature of 95-99° C.,
wherein the heating of the buffered fluid and the inflow of the heated fluid generates laminar flow across the surface of the one or more slides comprising formalin-fixed paraffin-embedded tissue;
removing dissolved wax and other debris from the surface of the buffered fluid in the tank;
withdrawing the one or more slides from the buffered fluid after removal of the dissolved wax and other debris.

8. The method of claim 7, further comprising the steps of:
positioning a low fluid level sensor in the tank below the position of the one or more slides in the tank,
wherein if the low fluid level sensor senses that the level of buffered fluid is below that of the slides then the tank fluid heating element will stop heating the buffered fluid.

9. The method of claim 7, further comprising the steps of:
positioning a high fluid level sensor in the tank above the position of the one or more slides in the tank,
wherein if the high fluid level sensor senses that the level of buffered fluid is above a certain height within the tank then the inflow of heated fluid to the tank will stop.

10. The method of claim 7, further comprising the steps of:
positioning a fluid tank temperature sensor in the tank,
wherein if the fluid tank temperature sensor senses that the temperature of the buffered fluid is above 99° C. then heating of the buffered fluid and inflow of the heated fluid will stop,
and wherein if the fluid tank temperature sensor senses that the temperature of the buffered fluid is below 95° C. then heating of the buffered fluid and inflow of the heated fluid will continue.

11. The method of claim 7, further comprising the steps of:
positioning a fluid inflow dispenser within the tank,
wherein the heated fluid inflows into the tank from the fluid inflow dispenser;
connecting the fluid inflow dispenser to a fluid inflow pump,
wherein the fluid inflow pump transports heated fluid from an external reservoir to the tank through the fluid inflow dispenser.

12. The method of claim 7, further comprising the steps of:
positioning a fluid inflow temperature sensor in the tank,
wherein if the fluid inflow temperature sensor senses that the temperature of the heated fluid is above 99° C. then inflow of the heated fluid will stop,
and wherein if the fluid inflow temperature sensor senses that the temperature of the heated fluid is below 95° C. then the heated fluid will stop and the temperature of the heated fluid will be adjusted to be in the range of 95-99° C.

13. The method of claim 7, further comprising the steps of:
positioning a fluid waste outlet within the tank,
wherein the fluid waste outlet is at the same height within the tank as the top surface of the buffered fluid comprising dissolved wax and debris;
outflowing the dissolved wax and other debris through the fluid waste outlet,
wherein the outflow is generated by a suction pump connected to the fluid waster outlet.

14. The method of claim 7, further comprising the steps of:
positioning a vertical fluid flow guide adjacent to the one or more slides,
wherein the vertical fluid flow guide comprises a heat convection fluid guide that is positioned at a height level above the surface of the one or more slides comprising formalin-fixed paraffin-embedded tissue.

15. The method of claim 7, further comprising the steps of:
positioning a horizontal fluid flow guide underneath a portion of the top surface of the buffered fluid,
wherein the horizontal fluid flow guide is connected to the fluid waste outlet,
and further wherein the outflow of dissolved wax and other debris flows across a surface of the horizontal fluid flow guide.

16. The method of claim 7, further comprising the steps of:
placing the one or more slides within a slide rack holder,
wherein the slide rack holder is contained with the tank of buffered fluid,
and further wherein the slide rack holder positions the one or more slides so that the laminar flow is parallel to the surface of the one or more slides comprising formalin-fixed paraffin-embedded tissue.

17. The method of claim 7, wherein the buffered fluid and the heated fluid comprise:
(a) a pH buffer solution with pH value ranging from 5 to pH 9.5,
(b) surfactants with total concentrations ranging from 0.01% to 5%
(c) formaldehyde scavengers
(d) oxidation reagents, wherein the molecule is selected from the group consisting of peroxide moiety, which can serve as an enzymatic substrate for peroxidase,
(e) surfactant synergistic reagents, and
(f) organic solutions to increase fluid boiling temperature.

18. The method of claim 17, wherein the pH buffer solution can be one or the combination of acetate buffer, MES buffer, citrate buffer, tris buffer, MOPS buffer, Phosphate buffer, HEPES buffer, BORATE buffer, EDTA buffer, and EGTA buffer.

19. The method of claim 17, wherein the surfactants comprise a variety of non-ionic and ionic surfactants with different length of hydrocarbon chains, such as Tween-20, Tween-80, Triton, Decyl Glucoside, Sodium Dodecyl Sulfate, Tergitol, and Ecosurf-SA9.

20. The method of claim 17, wherein the formaldehyde scavengers can be one or the combination of Sodium metabisulfite, urea, ethylene urea, ethylene glycol, diethylene glycol, glycerol, sorbitol, catechol, and resorcinol.
